(19) United States
(12) Patent Application Publication
(10) Pub. No.: US 2006/0123041 A1
(43) Pub. Date: Jun. 8, 2006

(54) Mode based action invocation through tag scanning

(75) Inventors: Marco Sandrini, Helsinki (FI); Martin Zilliacus, Kauniainen (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/006,107

(22) Filed: Dec. 7, 2004

(51) Int. Cl. G06F 17/00

(52) U.S. Cl. 707/102

(57) ABSTRACT

The invention provides seamless activation of a mobile terminal-integrated short-range communication reader along with activation and execution of an application required to further process the information read from a tag. In this regard, the user of the mobile terminal can intuitively control the applications/operations that will be triggered in connection with reading a short-range communication tag. As such the invention is able to provide an efficient and reliable means for accessing additional information related to the tag data, storing data included in the tag data or performing other functions related to the tag data.

### FIELD OF THE INVENTION

The present invention relates to short-range communication receivers (i.e., readers) and, more specifically to methods, devices, systems and computer program that provide mode based action invocation based on the scanning of a machine-readable tag.

### BACKGROUND OF THE INVENTION

Short-range wireless communication capability is becoming more prominent in a wide variety of mobile digital terminals, such as cellular phones, personal digital assistants, pagers and other mobile devices. By equipping such devices with requisite short-range communication readers or optical scanners the devices have the ability to communicate receive an unlimited amount of information. For example, mobile devices equipped with such readers are capable of receiving information from transponders, also referred as herein as tags. As more and more portable digital devices become equipped with short-range wireless communication readers, such as machine-readable code readers including Radio Frequency Identification (RFID) readers and code readers that read invisible or visible codes, such as a barcodes and the like, the device's ability to access information and services expands.

Short-range communication tags are typically simplistic in design; including an integrated circuit that incorporates the associated short-range communication circuitry and sufficient memory or other means to store the information that will be communicated to the transponder. Due to cost constraints and size limitations the amount of memory is typically very limited; which means the data that can be communicated from the tag to the reading device is also typically limited. To overcome the limitation in communicable data, tags are currently being implemented that provide access to additional information or require further action to access additional information. For example, a tag may include an Internet address in the form of a URL, in which case the user of the reading device, confronted with an Internet address read from a tag may choose to access the Internet address to obtain more information, place an order for a product or for any other purpose. In a similar fashion, a tag may include a telephone number, in which case the user of the reading device, confronted with a telephone number may choose to access the telephone number to obtain additional information, place an order for a product or for any other purpose. Such additional information is commonly referred to as “linking information”.

NeoMedia Technologies of Fort Myers, Fla., United States of America teaches how a mobile terminal such as a cellular telephone can incorporate a bar code imager that takes reads images of a printed barcode and, in turn, contacts to corresponding services on the Internet. Such teachings are also provided in U.S. Pat. No. 6,542,933, entitled “System and method of using machine-readable or human-readable linkage codes for accessing networked data resources”, issued on Apr. 1, 2003, in the name of inventors Durst Jr. et al and U.S. Pat. No. 6,434,561, entitled “Method and system for accessing electronic resources via machine-readable data on intelligent documents” issued on Aug. 13, 2002, in the name of inventors Durst Jr. et al.

Airclic Incorporated of Newton, Pa., United States of America teaches how SmartCodes™ can be used for accurate and efficient access into any device that a user is carrying, such as a cellular phone. The SmartCodes™ provide the benefit of the user not having to enter long alphanumeric codes on the small keyboards in order to access the devices. In one example, the scanning of the SmartCode™ may occur with a bar code scanner that is integrated with a mobile terminal, such as a cellular telephone or the like. Such teachings are also provided in U.S. Pat. No. 6,753,883, entitled “Printed medium activated interactive communication of multimedia information, including advertising”, issued on Jun. 22, 2004, in the name of inventors Schema, et al. and U.S. Pat. No. 6,691,914, entitled “Method and system for directing end user to network location of provider based on user-provided codes”, issued on Feb. 17, 2004, in the name of inventors Isherwood, et al.

In addition to linking information a tag may include other information, linking information or otherwise, that a user desires to store. For example, a user may desire to store for later use a telephone number, an Internet address, full contact information or the like.

Typically if tag includes linking information or information that a user desires to store it requires the user to make a decision as whether the linking information should be used or whether information should be stored. In the case of linking information, this will typically require the user to launch or activate an application related to the information, such as an Internet browser application, a telephone call application or the like. In addition, it may be necessary for the user to interface with the application, i.e., input the Internet address or telephone number, if the linking information is not hyperlinked or the like. In the case of information that requires storing, the user will typically be required to choose an application for storing the information and, in some instances, manually provide the information to the application. This process requires a great deal of user interface with the reading device and, such user interface is highly inefficient in terms of the time required to access information or store information. In addition, the process is unreliable because user interaction can result in errors in accessing or storing information.

In addition, to linking information or storing information other intentional actions on behalf the user may be required to receive data from a short-range communication. For example, a terminal integrated with a machine-readable code reader, such as a bar code scanner or the like may require manual activation of the scanner to read the data. An RFID reader may also require manual activation to perform reading of a tag in order to provide overall energy management (i.e., saving battery power) to the mobile terminal. All of these manual functions add to overall inefficiency in short-range communication.

Thus a need exists to develop systems, devices and corresponding methods and computer programs for providing seamless activation of a mobile terminal-integrated short-range communication reader and the linking or storage of information read from a tag. The desired device and methods should provide for minimal user interaction, thereby resulting in an efficient and reliable process. In addition, the desired device and methods should rely on existing mobile terminal hardware architecture and, in specifically, utilize pre-existing user interfaces on the mobile terminal.

### BRIEF SUMMARY OF THE INVENTION

The present invention provides for methods, systems, devices and computer programs for providing seamless activation of a mobile terminal-integrated short-range communication reader and the activation and execution of applications required to further process the information included in correspondence read by the reader. In this regard, the user of the mobile terminal can intuitively control the applications/operations that will be triggered in connection with reading a short-range communication tag. As such the invention is able to provide an efficient and reliable means for accessing additional information related to the tag data, storing data included in the tag data or performing other functions related to the tag data. In addition, the present invention uses conventional mobile terminal user-interfaces to initiate the automated process of reader activation, data reading and activation and execution of an application associated with the user-interface and the read tag data.

In one embodiment of the invention a mobile terminal apparatus is defined. The apparatus includes a user interface for receiving an input from a user of the mobile terminal, a short-range communication reader and a processing device in communication with the short-range communication receiver and the user interface. In response to a user input to the user interface, the processing unit provides for activation of the short range communication reader and executes an application associated with the user interface. The application is activated upon reading data from a short-range communication source and the data is used in the application. The short-range communication reader may be any receiver capable of reading short range communication. For example, a Radio Frequency Identification (RFID) reader, a visual code (i.e., bar code or the like) reader/scanner or any other scanner.

The user interface will typically be embodied in a mobile terminal input key. For example, the user interface may be the telephone initiation key, a message initiation key, a web browser initiation key, a telephone book key or the like. The input that is provided to the user interface will typically vary from the standard input that is provided to the user interface. This is because the standard input, i.e., a “press and release” input will result in standard mobile terminal functionality. In one embodiment of the present invention, for example, performing a “press and hold” input to the user interface will provide for activation of the short-range communication reader and, subsequently, the application.

The application that is activated and executed by the processing unit will be associated with the user interface. For example, if the user interface is telephone call initiation key, the application will typically be an automated telephone call application. If the user interface is Internet browser initiation key, the application will typically be an Internet browser application. If the user interface is message service initiation key, the application will typically be a message service application. If the user interface is a telephone book key, the application will typically be a telephone book application.

The application is not launched upon initial user input to the user interface, but instead, the application is launched once the reader has been activated and a tag has been read that includes data that will be used in the application. For example, if the application is an automated telephone call application, the tag information will include a telephone number and the application will be responsible for automatically dialing, i.e., placing the telephone call to the number If the application is an Internet browser application, the tag information will include an Internet address and the application will be responsible for locating the Internet address and presenting the user the web page associated with the address. If the application is a telephone book application, the tag information will include contact information and the application will be responsible for storing the contact information in the telephone book. If the application is a message service application, the tag information will include a message address or a number depending on the application and the application will be responsible for either providing a blank message in which the user types a message, or actually sending a pre-configured message.

Alternatively, the application may be launched upon a user input to mobile terminal. For example, in one embodiment reading of the tag information may provide for display of application-related information, i.e., a telephone number, Internet address or the like, and a prompt for the user to select activation of the application or to disregard the application. In another embodiment, in which the tag information is related to two or more applications, the reading of the tag information may provide for display of information related to two or more applications and the user is provided with a choice as to which application should be activated or the order of activation.

Once the application is launched one or more user inputs to the terminal may be required to execute the application or complete the communication. In one embodiment, in which Short messaging Service (SMS) is launched, a user may be required to input message text or to provide a send communication input.

The invention is further defined by a method for providing a mobile terminal seamless scanning of a short-range communication tag and activation of an application related to the data included in the tag. The method includes the steps of providing a user input to a predefined user interface, activating a short-range communication reader integrated with the mobile terminal in response to the user input, reading data from a short-range communication tag, activating an application associated with the user interface and executing the application using data read from the short-range communication tag.

The step of providing a user input to a predefined user interface typically defines the user interface as a mobile terminal input key, such as the telephone initiation key, the message initiation key, the web browser initiation key, the telephone book key or the like. The user input that is defined by this step will typically involve an alternate keystroke function, such as a “press and hold” keystroke that will then provide for the additional steps of the method to occur.

The step of activating a short-range communication reader integrated with the mobile terminal in response to the user input further defines the short-range communication reader as any known or future reader. Typical readers include a machine-readable code reader including an RFID reader and code readers that read invisible or visible code, such as barcode and the like.

The step of reading data from a short-range communication tag will typically further include the step of identify data from the short-range communication tag that is associated with the predefined user interface and disregarding data that is unassociated with the predefined user interface. For example, if the user interface is the telephone call initiation key the method will identify a telephone number in the tag data and disregard all other data in the tag. If the tag information is found not to include the requisite information, the user of the mobile terminal will typically be provided an error message, via an associated display, or some other indication that the method is being interrupted.

The step of activating an application associated with the user interface may include activating an automated telephone call application. In which case, the step of executing the application using data read from the short-range communication tag may typically include using a telephone number read from the short-range communication tag to automatically initiate the telephone call. In an alternate embodiment, the step of activating an application associated with the user interface may include activating an Internet browser application. In which case, the step of executing the application using data read from the short-range communication tag may typically include using an Internet address read from the short-range communication tag to locate a web page on the Internet. In another embodiment, the step of activating an application associated with the user interface may include activating a telephone book application. In which case, the step of executing the application using data read from the short-range communication tag may typically include using contact information read from the short-range communication tag and storing the information in the telephone book. In yet another embodiment, the step of activating an application associated with the user interface may include activating a message service application. In which case, the step of executing the application using data read from the short-range communication tag may typically include using a message address read from the short-range communication tag to initiate the sending of a message.

In alternative embodiments of the method, the step of providing user inputs to the terminal may be required prior to activation of the application. The user inputs may be in response to the display of information read from the tag, for example, a telephone number or an Internet address. In this example, the user is provided with the option of activating the application or choosing to disregard the application. Additionally, the step of providing inputs may entail choosing from amongst multiple applications associated with the read tag information. For example, if the tag information includes a telephone number and an Internet address, a user may be provided, through the display, options as to which application should be activated.

An alternate embodiment of the invention is defined by a computer program product for activating a short-range communication reader integrated in a mobile terminal and automatically processing data read by the reader. The product includes a computer readable storage medium having computer-readable program instructions embodied in the medium. The computer-readable program instructions include first instructions for activating the short-range communication reader in response to user input to a predefined user interface and second instructions for activating an application associated with the predefined user interface in response to reading application-related data from a short-range communication tag. The computer-readable program instructions may include, optional, third instructions for determining if a short-range communication tag includes data that is associated with the user interface as a prerequisite to activating the application.

The first instructions may further define the predefined user interface as a user input key, such as the telephone initiation key, the message initiation key, the web browser initiation key, the telephone book key or any other input key. The first instructions may also define the user input as an alternative keystroke, such as a “press and hold” keystroke that differs from the conventional “press and release” keystroke.

The second instructions may further define the application as an automated telephone call application that is activated in response to reading a telephone number from the tag, an Internet browser application that is activated in response to reading an Internet address from the tag, a telephone book application that is activated in response to reading contact information from the tag, a message service application that is activated in response to reading a message address from the tag.

The invention is also defined by a system for providing short-range communication to a mobile terminal. The system includes a mobile terminal having an integrated short-range communication reader and a short-range communication tag, i.e., transponder. The short-range communication reader and tag may be any short-range communication reader and tag, such as a machine-readable code reader and tag including an RFID reader and code readers and associated tags that read invisible or visible tags, such as barcode and the like.

The mobile terminal will also include a user interface for receiving an input from a user, a processing device in communication with the short-range communication receiver and the user interface. The processing device provides for activation of the short-range communication reader in response to a user input to the user interface. The mobile terminal additionally includes an application executed by the processing device and associated with the user interface. The application will be automatically activated once the short-range communication reader reads the data and the application is executed using the data. As previously described, the application may be further defined as an automated telephone call application, an Internet browser application, a messaging service application and a telephone book application.

Thus, the present invention provides systems, devices and methods for providing seamless activation of a mobile terminal-integrated short-range communication reader and the activation and execution of applications required to further process the information read from a corresponding tag. In this regard, the user of the mobile terminal can intuitively control the applications/operations that will be triggered in connection with reading a short-range communication tag. As such the invention is able to provide an efficient and reliable means for accessing additional information related to the tag data, storing data included in the tag data or performing other functions related to the tag data. In addition, the present invention uses conventional mobile terminal user-interfaces to initiate the automated process of reader activation, data reading and activation and execution of an application associated with the user-interface and the read tag data.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for broadcast communication short-range wireless communication and wireless cellular network communication, in accordance with an embodiment of the present invention.

FIG. 2 is a flow diagram of a method for providing a mobile terminal seamless scanning of a short-range communication tag and activation of an application related to the data included in the tag, in accordance with an embodiment of the present invention.

FIG. 3 is a block diagram depicting the flow of a specific method for seamless scanning of a tag and activation of an automatic telephone call application, in accordance with an embodiment of the present invention.

FIG. 4 is a block diagram of a mobile terminal, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

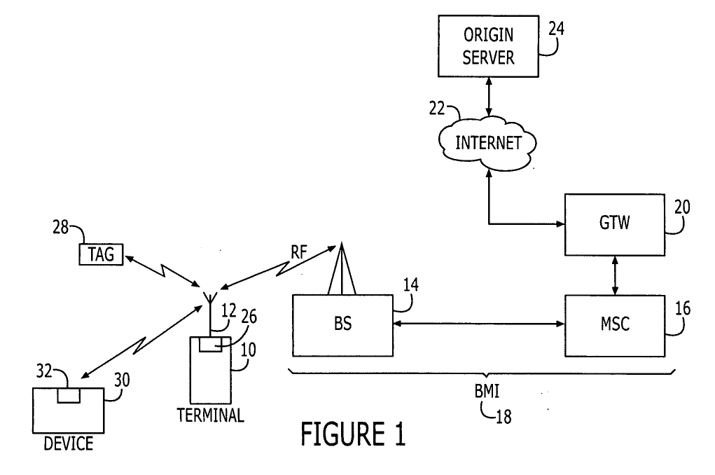

Referring to FIG. 1, a block diagram of a broadcast network, a short-range communication network and a cellular network, collectively referred to as composite network 10 is shown, in accordance with an embodiment of the present invention. It is noted that while a cellular network is not an essential part of the present invention, it is shown in this figure to illustrate that the mobile terminal device 12, in this example is a cellular terminal, may be readily equipped to communicate via a cellular network in addition to the short-range communication medium. The composite network will typically include a plurality of terminals, although for the sake of clarity only one terminal is shown. As shown, the terminal will include an antenna 12 for transmitting and receiving both cellular network signals and short-range communication signals.

The cellular communication network includes a base site or base station (BS) 14. The base station is a part of a cellular network that includes elements required to operate the network, such as a mobile switching center (MSC) 16. As is known by those of ordinary skill in the art of telecommunications, the cellular network may also be referred to as a Base Station, Mobile Switching Center and Interworking function (BMI) 18. In operation, the MSC is capable of routing calls and messages to and from the terminal when the terminal is making and receiving calls. The MSC also provides a connection to landline trunks when the terminal is involved in a call. Further, the MSC can, but need not, be coupled to a gateway server GTW 20.

The MSC 16 can be coupled to a network, such as a local area network (LAN), a metropolitan area network (MAN), and/or a wide area network (WAN). The MSC can be coupled to the network directly, or if the system includes a GTW 20 (as shown), the MSC can be coupled to the network via the GTW. In one configuration, for example, the MSC is coupled to the GTW, and the GTW is coupled to a WAN, such as the Internet 22. In turn, devices such as processing elements (e.g., personal computers, server computers or the like) can be coupled to the terminal 10 via the Internet. For example, the processing elements can include one or more processing elements associated with an origin server 24.

In addition to optional cellular network communication, the terminal 10 of the present invention will be equipped to communicate with other devices via short-range communication techniques. In this regard, the terminal will include a short-range communication receiver 26, i.e. reader, capable of scanning and/or reading machine-readable codes, such as RFID, barcode and the like. The short range communication techniques include, but are not limited to RFID, Bluetooth® (i.e., communication in the about 2.4 GHz frequency band), Infrared (IR), Wireless Local Area Network (WLAN), IrDA (Infrared Data Association), UWB (Ultra Wideband) or the like. The visual coding techniques would include visual or invisible printable codes (such as 1D and 2D bar codes, SmartCode™, digital watermarks and the like), ink based codes (such as magnetic, UV, conductive ink based codes or the like), substrate based codes (such as Microwire, DataDots or the like) or other machine-readable tag coding technologies. In the FIG. 1 embodiment the terminal 12 is in short-rang communication with transponder 28, i.e., tag and device 30 equipped with internal short-range transponder/tag 32 through a short-range interface. As will be appreciated, the electronic devices and tags can comprise any of a number of different known devices and tags capable of transmitting and/or receiving data in accordance with any of a number of different short-range communication techniques.

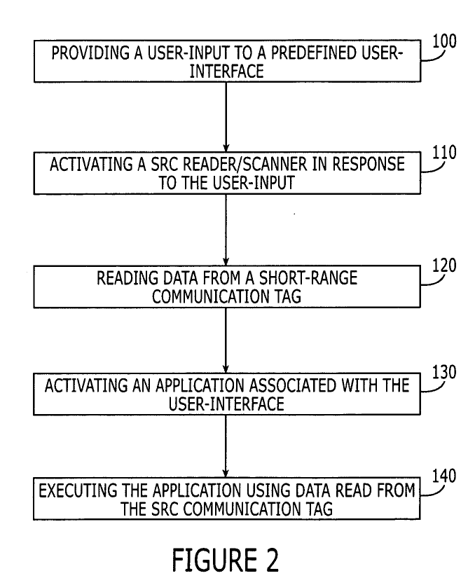

FIG. 2 is a flow diagram of a method for providing a mobile terminal seamless scanning of a short-range communication tag and activation of an application related to the data included in the tag, in accordance with an embodiment of the present invention. At step 100, a user-input is provided to a predefined user-interface. The user interface may be a mobile terminal key pad or button, a touch-screen display, a voice command or the like. In specific embodiments of the invention, such as a cellular telephone embodiment, the user interface may include the telephone call key, the message service key, the Internet browser key, the telephone book key and the like. The user input may be any pre-configured input designated by the configuration of the terminal. For example, in one specific embodiment the user-input is defined as a “press and hold” input. In this regard, a standard “press and release” input will result in the standard key function and the “press and hold” input will result in the method of the present invention illustrated in FIG. 2. By way of example, if the user interface is the telephone call key, the “press and release” input will result in the standard function, such as displaying a “previously called” list and “the press and hold” input will result in the method of the present invention.

At step 110, the short-range communication reader integrated with the mobile terminal is activated in response to the user input. The short-range communication reader may be any short-range communication reader capable of being integrated with a mobile terminal. For example, the reader may be a machine-readable code reader, such as a RFID reader or a visual (i.e., barcode or the like) or invisible code reader/scanner or the like. Activation of the reader will involve activation of the scanner hardware, as well as, activation of the software (i.e., computer programs, modules, applications, etc) related to the scanner. At step 120, the short-range communication reader reads data from a short-range communication tag. This step will typically entail either having the reader within the communication range of the tag or directing the scanner at the tag, in order to read a machine-readable short-range-communication tag. Reading of the data from the short-range communication tag may optionally include the sub-step of isolating the data within the tag that is associated with the user interface. For example, if the user interface is a telephone call key, the reading operation may be configured to isolate or process a telephone number within the read data, such that other extraneous data read from the data is ignored (i.e., not susceptible to further processing). In this regard, if the user interface is a telephone call key and the tag included a telephone number and an Internet address, the telephone call would be isolated and processed and the Internet address would be ignored. The opposite isolation and processing would occur if the user interface is defined as the Internet browser key. Once the data from the tag has been read, the reader/scanner hardware will be deactivated.

At step 130, an application associated with the user interface is activated based upon user-interface related data being read from the tag. By way of example, the application may be an automated telephone call application, a message service application, an Internet browser application, a telephone book application or the like. As such, if the user interface is defined as the telephone call key, the application will typically be the automated telephone call application and the application will be activated based upon a telephone number being read from the tag. If the user interface is defined as the message service key, the application will typically be the message service application and the application will be activated based upon a message address being read from the tag. If the user interface is defined as the Internet browser key the application will typically be the Internet browser application and the application will be activated based upon an Internet address (i.e., URL) being read from the tag. If the user interface is defined as telephone book key the application will typically be the telephone book application and the application will be activated based upon contact information being read from the tag. If no user-interface related data is found in the tag or if the data is not valid or corrupt, no application will be activated and the user will typically informed that the method has been discontinued. The user may be notified by an audible command, an visual command, such as a displayed error message, or the like.

Optionally, prior to activating the application the mobile terminal may present the user with options regarding the information read from the tag. For example, if the tag information includes a telephone number and an network address, the terminal may provide the user, via a user interface, typically a display, a choice as to whether the telephone number should be called (i.e., launch and dial the telephone number) or whether the network address should be accessed (i.e., launch an Internet browser application and access the address). In another embodiment, the application related to the tag information may be activated based on the discretion of the user. In this example, the user may be presented with an option, via a user interface, typically the display, as to whether the application (telephone, Internet browser, etc.) should be activated or whether the information read from the tag should be disregarded.

At step 140, the application is executed using the user-interface related data from the tag. For example, if the application is an automated telephone call application, then the telephone number in the tag data is automatically dialed and the call is place. If the application is the Internet browser application, then the Internet address in the tag data is located and the related web page displayed. If the application is the telephone book application, then the contact information in the tag data is automatically stored in the telephone book. If the application is the message service application, then the message address in the tag data is used to automatically address a message that is to be sent.

Optionally, the launching of the application may provide for the user of the application to input additional data into the application, in order for the application to provide communication or another function. For example, if the launched application is a Short Messaging Service (SMS) application, the application or the terminal may require the user to provide inputs, such as additional message text or a “send” input”, in order to complete the message or the communication of the message.

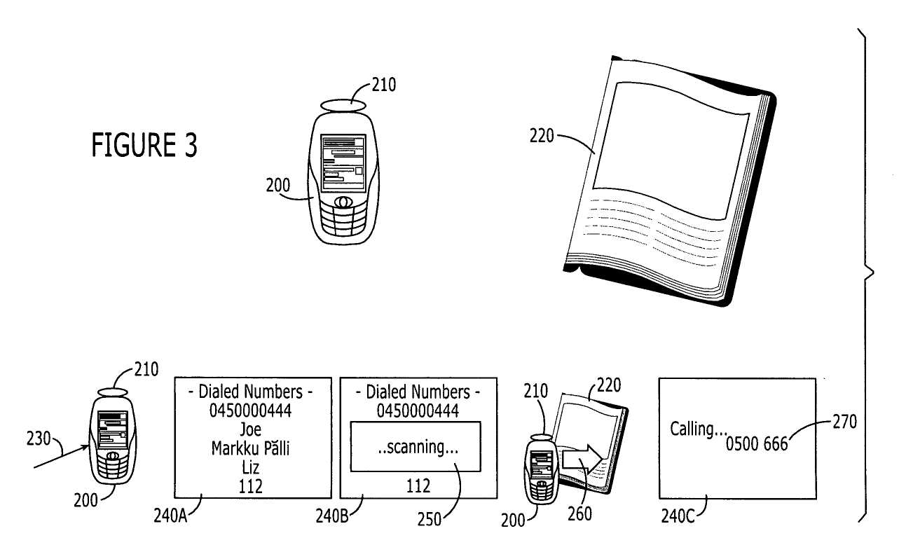

FIG. 3 provides a specific example of a method for providing a mobile terminal seamless scanning of a short-range communication tag and activation of an application related to the data included in the tag, in accordance with an embodiment of the present invention. The mobile terminal is defined as a cellular telephone 200 integrated with a machine-readable code reader, such as, for example a RFID or visual/invisible code reader 210. The user of the cellular telephone desires to read a machine-readable tag, such as, for example a RFID tag or visible/invisible code tag that is incorporated in an advertisement in a magazine 220. The advertisement indicates that the tag data includes a telephone number. The user will initiate the tag reading process by providing an input to the pre-defined user-interface. In the illustrated example, the arrow 230 indicates that the user has provided a “press and hold” input to the telephone call key. The mobile terminal display 240A will initially display a listing of the most recent previous calls (i.e., the function related to a “press and release input). After a predetermined time of holding the key in a press mode, for example 2 seconds, the reader/scanner hardware and software will be activated. The mobile terminal display 240B will indicate, for example a separate display window 250, that scanning has been initiated. Once the scanner is activated the user will direct the device and scanner/reader at the magazine article (illustrated by arrow 260) while continue to hold the key in a press mode. This will allow for the tag to be read by the integrated reader.

Once the tag has been read and the user-interface related data has been identified, in this example, a telephone number, the automated telephone call application is activated and a telephone call is placed to the number in the tag data. In alternate embodiments, the user may be provided the option of making the telephone call or disregarding the telephone number. Additionally, in embodiments in which the tag information is related to multiple applications the user may be presented options concerning which application the user desires to launch. Once the application automatically or at user discretion initiates the telephone call, the mobile terminal display 240C indicates that a call is being made and displays the number 270 that is being dialed.

It will be understood that each block or step of the flowchart in FIG. 2 and the example of FIG. 3, and combinations of blocks in the flowchart, can be implemented by computer program instructions. These computer program instructions may be loaded onto a computer or other programmable apparatus, such as a processor of the mobile terminal, to produce a machine, such that the instructions which execute on the computer or other programmable apparatus create means for implementing the functions specified in the flowchart block(s) or step(s). These computer program instructions may also be stored in a computer-readable memory of the mobile device that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems that perform the specified functions or steps, or combinations of special purpose hardware and computer instructions.

In one embodiment of the invention a computer program product for activating a short-range communication reader integrated in a mobile terminal and automatically processing data read by the reader is defined. The product includes a computer readable storage medium having computer-readable program instructions embodied in the medium. The computer-readable program instructions include first instructions for activating the short-range communication reader in response to user input to a predefined user interface and second instructions for activating an application associated with the predefined user interface in response to reading application-related data from a short-range communication tag. The computer-readable program instructions may additionally include third instructions for determining if a short-range communication tag includes data that is associated with the application as a prerequisite to activating the application.

The first instructions may define the predefined user interface as a telephone initiation key, a message initiation key, a web browser initiation key and a telephone book key or any other input key, touch-screen function, voice command or the like. The first instructions may additionally define the user input as a press and hold keystroke.

The second instructions may define the application as an automated telephone call application, a message service application, an Internet browser application, a telephone book application or the like. In these examples, the automated telephone application is activated based on a telephone number in the tag data, the message service application is activated based on a message address in the tag data, the Internet browser application is activated based on an Internet address in the tag data and the telephone book application is activated based on contact information in the tag data. In addition to activating an application associated with the predefined user interface in response to reading application-related data from a short-range communication tag, the second instructions may provide for activating the application in response to a user input. In this alternate embodiment the application is activated based on reading application-related data and an input by the user that signifies that the user desires the launching of the application.

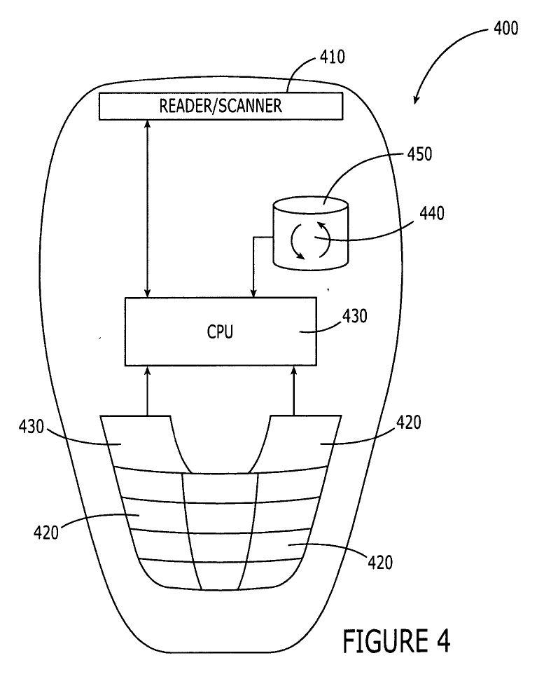

FIG. 4 is a block diagram of a mobile terminal, in accordance with an embodiment of the present invention. The mobile terminal 400 may be embodied in a cellular telephone, a personal digital assistant (PDA), a pager or any other type of mobile terminal. The mobile terminal will include a short-range communication reader 410. For the purposes of this invention the term reader includes any short-range communication transceiver, receiver or reader, as well as, any visible or invisible code reader, such as a bar code scanner. The short range communication reader may be and machine-readable code reader, such as a Radio Frequency Identification (RFID) reader, a visible code reader/scanner, such a barcode reader, an invisible code reader or the like. In one specific example, a visual code reader is embodied in a digital camera integrated with a cellular telephone equipped with a scanning circuit or requisite software capable of reading and interpreting visual codes.

The mobile terminal will additionally include one or more user interfaces 420 for receiving an input from a user of the mobile terminal. In the illustrated example of FIG. 2 the user interfaces are, by example, input keys, such as cellular telephone keys. Additionally, the user interface may be embodied in a touch-screen display, voice commands provided to the mobile terminal or the like. In one specific embodiment of the invention, pre-defined input keys are configured such that an alternative input, such as a “press and hold” input is required to activate the short-range communication reader, thereby, initiating the routine of the present invention. The “press and hold” input requires that the key be depressed and held for a certain period prior to activating the reader/scanner.

The mobile terminal will additionally include a processing device 430 that is in communication with the short-range communication reader and the one or more user interfaces. The processing device will responds to the input of a pre-defined user interface by activating the short-range communication reader. Once activated, the reader, typically directed at a tag by the user, will read or scan data from the tag. The processor will determine data in the tag that is associated with the user-interface. If such data is found in the tag, the processor will activate an application 440 that is associated with the user-interface. In the illustrated embodiment the application is stored in memory unit 450 that is in communication with and accessible to the processing device. In alternate embodiment, the application may reside on memory located on the processing device or reside in a logic device. Once the application is activated, it executed using the user-interface related data from the read tag.

A system embodiment of the present invention includes the mobile terminal device of FIG. 4 in addition to a corresponding short-range communication tag. The tag of system embodiment will include data is applicable to one or more of the applications being executed on the mobile terminal.

Thus, the present invention provides systems, devices and methods for providing seamless activation of a mobile terminal-integrated short-range communication reader and the activation and execution of applications required to further process the information read from a corresponding tag. In this regard, the user of the mobile terminal can intuitively control the applications/operations that will be triggered in connection with reading a short-range communication tag. As such the invention is able to provide an efficient and reliable means for accessing additional information related to the tag data, storing data included in the tag data or performing other functions related to the tag data. In addition, the present invention uses conventional mobile terminal user-interfaces to initiate the automated process of reader activation, data reading and activation and execution of an application associated with the user-interface and the read tag data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile terminal apparatus, the apparatus comprising:
a user interface for receiving an input from a user of the mobile terminal;
a short-range communication reader; and
a processing device in communication with the short-range communication reader and the user interface, wherein, in response to a predefined user input to the user interface, the processing unit provides for activation of the short range communication reader and activates an application associated with the user interface, wherein the application is activated upon reading data from a proximate short-range communication source and the read data is used in the application.

2. The mobile terminal of claim 1, wherein the user interface is further defined as a mobile terminal input key.

3. The mobile terminal of claim 1, wherein the user interface is further defined as a mobile terminal input key chosen from the group of user interfaces consisting of a telephone initiation key, a message initiation key, a web browser initiation key and a telephone book key.

4. The mobile terminal of claim 1, wherein the short-range communication reader is further defined as a Radio Frequency Identification (RFID) reader.

5. The mobile terminal of claim 1, wherein the short-range communication reader is further defined as a machine-readable code reader.

6. The mobile terminal of claim 5, wherein the machine-readable code reader is further defined as a visual code reader.

7. The mobile terminal of claim 6, wherein the visual code reader is further defined as a digital camera integrated in the terminal.

8. The mobile terminal of claim 1, wherein the short-range communication reader is further defined as capable of reading short-range communication in the about 2.4 giga hertz (GHz) frequency band.

9. The mobile terminal of claim 1, wherein the application executed by the processing unit is further defined as an automated telephone call application and the data from the short-range communication source is further defined as a telephone number.

10. The mobile terminal of claim 1, wherein the application executed by the processing unit is further defined as an Internet browser application and the data from the short-range communication source is further defined as an Internet protocol address.

11. The mobile terminal of claim 1, wherein the application executed by the processing unit is further defined as a telephone book application and the data from the short-range communication source is further defined as contact information.

12. The mobile terminal of claim 1, wherein the application executed by the processing unit is further defined as a message service application and the data from the short-range communication source is further defined as a message address.

13. The mobile terminal of claim 12, wherein the application executed by the processing unit is further defined as a message service application and the data from the short-range communication source is further defined as message content.

14. The mobile terminal of claim 1, wherein the application is activated upon reading data from a proximate short-range communication source and upon a user input to the terminal that indicates the user's desire to activate the application.

15. A method for providing a mobile terminal seamless scanning of a short-range communication tag and activation of an application related to the data included in the tag; the method comprising the steps of:
providing a user input to a predefined user interface;
activating a short-range communication reader integrated with the mobile terminal in response to the user input;
reading data from a proximate short-range communication tag;
activating an application associated with the user interface in response of reading data from the tag; and
executing the application using data read from the short-range communication tag.

16. The method of claim 15, wherein the step of providing a user input to a predefined user interface further comprises providing a user input to a predefined user input key.

17. The method of claim 16, wherein the step of providing a user input to a predefined user input key further comprises providing a user input to a predefined user input key, wherein the predefined user input key is chosen from the group consisting of a a telephone initiation key, a message initiation key, a web browser initiation key and a telephone book key.

18. The method of claim 15, wherein the step of providing a user input to a predefined user interface further comprises providing a press and hold keystroke to a predefined user interface.

19. The method of claim 15, wherein the step of activating a short-range communication reader integrated with the mobile terminal in response to the user input further comprises activating a machine-readable code reader integrated with the mobile terminal in response to the user input.

20. The method of claim 19, wherein the step of activating a machine-readable code reader integrated with the mobile terminal in response to the user input further comprises activating a visual code reader integrated with the mobile terminal in response to the user input.

21. The method of claim 20, wherein the step of activating a visual code reader integrated with the mobile terminal in response to the user input is further defined as activating a digital camera integrated in the mobile terminal in response to the user input.

22. The method of claim 15, wherein the step of activating a short-range communication reader integrated with the mobile terminal in response to the user input further comprises activating a Radio Frequency Identification (RFID) reader integrated with the mobile terminal in response to the user input.

23. The method of claim 15, wherein the step of reading data from a proximate short-range communication tag further comprises identifying data from the short-range communication tag that is associated with the predefined user interface and disregarding data that is unassociated with the predefined user interface.

24. The method of claim 15, wherein the step of activating an application associated with the user interface in response of reading data from the tag further comprises the step providing a application-activating user input to the mobile terminal prior to activating the application.

25. The method of claim 15, wherein the step of activating an application associated with the user interface in response of reading data from the tag further comprises the step choosing, by user input, the application associated with the user interface from a plurality of applications associated with the user interface prior to activating the application.

26. The method of claim 15, wherein the step of activating an application associated with the user interface in response of reading data from the tag further comprises activating an automated telephone call application.

27. The method of claim 26, wherein the step of executing the application using data read from the short-range communication tag further comprises executing the automated telephone call application using a telephone number read from the short-range communication tag.

28. The method of claim 15, wherein the step of activating an application associated with the user interface further in response of reading data from the tag comprises activating an Internet browser application.

29. The method of claim 28, wherein the step of executing the application using data read from the short-range communication tag further comprises executing the Internet browser application using an Internet protocol address read from the short-range communication tag.

30. The method of claim 15, wherein the step of activating an application associated with the user interface in response of reading data from the tag further comprises activating a telephone book application.

31. The method of claim 30, wherein the step of executing the application using data read from the short-range communication tag further comprises executing the telephone book application using contact information read from the short-range communication tag.

32. The method of claim 15, wherein the step of activating an application associated with the user interface in response of reading data from the tag further comprises activating a message service application.

33. The method of claim 32, wherein the step of executing the application using data read from the short-range communication tag further comprises executing the message service application using a message address read from the short-range communication tag.

34. The method of claim 15, wherein the step of executing the application using data read from the short-range communication tag further comprises the step of providing user inputs to the mobile terminal to execute the application.

35. A computer program product for activating a short-range communication reader integrated in a mobile terminal and automatically processing data read by the reader, the product comprising a computer readable storage medium having computer-readable program instructions embodied in the medium, the computer-readable program instructions comprising:
first instructions for activating the short-range communication reader in response to user input to a predefined user interface; and
second instructions for activating an application associated with the predefined user interface in response to reading application-related data from a short-range communication tag.

36. The computer program product of claim 35, further comprising third instructions for determining if a short-range communication tag includes data that is associated with the application as a prerequisite to activating the application.

37. The computer program product of claim 35, wherein the first instructions for activating the short-range communication reader in response to user input to a predefined user interface further defines the predefined user interface as chosen from the group consisting of a telephone initiation key, a message initiation key, a web browser initiation key and a telephone book key.

38. The computer program product of claim 35, wherein the first instructions for activating the short-range communication reader in response to user input to a predefined user interface further defines the user input as a press and hold keystroke.

39. The computer program product of claim 35, where the second instructions for activating an application associated with the predefined user interface in response to reading application-related data from a short-range communication tag further comprises instructions for activating the application associated with the predefined user interface in response to a user input to the terminal.

40. The computer program product of claim 35, where the second instructions for activating an application associated with the predefined user interface in response to reading application-related data from a short-range communication tag further comprises instructions providing the user a choice of applications from a plurality of applications prior to activating the application.

41. The computer program product of claim 35, wherein the second instructions for activating an application associated with the predefined user interface in response to reading application-related data from a short-range communication tag further comprises activating an automated telephone call application associated with the predefined user interface in response to reading a telephone number from the short-range communication tag.

42. The computer program product of claim 35, wherein the second instructions for activating an application associated with the predefined user interface in response to reading application-related data from a short-range communication tag further comprises activating an Internet browser application associated with the predefined user interface in response to reading an Internet protocol address from the short-range communication tag.

43. The computer program product of claim 35, wherein the second instructions for activating an application associated with the predefined user interface in response to reading application-related data from a short-range communication tag further comprises activating a telephone book application associated with the predefined user interface in response to reading contact information from the short-range communication tag.

44. The computer program product of claim 35, wherein the second instructions for activating an application associated with the predefined user interface in response to reading application-related data from a short-range communication tag further comprises activating a message service application associated with the predefined user interface in response to a message address from the short-range communication tag.

45. A system for providing short-range communication to a mobile terminal, the system comprising:
a mobile terminal including:
a user interface for receiving an input from a user,
a short-range communication reader,
a processing device in communication with the short-range communication receiver and the user interface that provides for activation of the short-range communication reader in response to a predefined user input to the user interface, and
an application executed by the processing device and associated with the user interface; and
a short-range communication tag that includes data that is intended for use with the application,
wherein the application is activated once the short-range communication reader reads the data and the application is executed using the read data.

46. The system of claim 45, wherein the user interface for receiving an input from a user is further defined as an input key.

47. The system of claim 45, wherein the user interface for receiving an input from a user is further defined as chosen from the group of user interfaces consisting of a telephone initiation key, a message initiation key, a web browser initiation key and a telephone book key.

48. The system of claim 45, wherein the short range communication reader is further defined as a visual code reader and the short range communication tag is further defined as a visual code tag.

49. The system of claim 45, wherein the short range communication is further defined as a Radio Frequency Identification (RFID) reader and the short range communication tag is further defined as an RFID tag.

50. The system of claim 45, wherein the short range communication is further defined as a machine-readable code reader and the short range communication tag is further defined as a machine-readable tag.

51. The system of claim 45, wherein the application executed by the processing device and associated with the user interface is further defined as an automated telephone call application.

52. The system of claim 45, wherein the short-range communication tag that includes data that is intended for use with the application further defines the data as a telephone number.

53. The system of claim 45, wherein the application executed by the processing device and associated with the user interface is further defined as an Internet browser application.

54. The system of claim 53, wherein the short-range communication tag that includes data that is intended for use with the application further defines the data as a an Internet protocol address.

55. The system of claim 45, wherein the application executed by the processing device and associated with the user interface is further defined as a messaging service application.

56. The system of claim 55, wherein the short-range communication tag that includes data that is intended for use with the application further defines the data as a message address.

57. The system of claim 45, wherein the application executed by the processing device and associated with the user interface is further defined as a telephone book application.

58. The system of claim 57, wherein the short-range communication tag that includes data that is intended for use with the application further defines the data as contact information.

59. The system of claim 45, wherein the application is activated once the short-range communication reader reads the data and once the user of the terminal provides a user input that indicates the user's intent to activate the application.

60. The system of claim 45, wherein the application is activated once the short-range communication reader reads the data and once the user of the terminal chooses the application from a plurality of applications associated with the read data.
